(19) United States
(12) Patent Application Publication
(10) Pub. No.: US 2018/0365709 A1
(43) Pub. Date: Dec. 20, 2018

(54) PERSONALIZED CREATOR RECOMMENDATIONS

(71) Applicant: Adobe Systems Incorporated, San Jose, CA (US)

(72) Inventors: Natwar Modani, Bengaluru (IN); Palak Agarwal, Kanpur (IN); Gaurav Kumar Gupta, Roorkee (IN); Deepali Jain, Kadubeesanahalli (IN); Ujjawal Soni, Chennai (IN)

(73) Assignee: Adobe Systems Incorporated, San Jose, CA (US)

(21) Appl. No.: 15/625,237

(22) Filed: Jun. 16, 2017

(51) Int. Cl. G06Q 30/02; G06F 17/30; G06F 7/02

(52) U.S. Cl. CPC G06Q 30/0201; G06F 7/026; G06F 17/30867

(57) ABSTRACT

Techniques are disclosed for generating personalized creator recommendations to viewers interested in viewing and interacting with creative works, in the context of a creative platform for publishing and viewing creative works. For each creator, a vector is generated indicating that creator's creative output with respect to a set of one or more creative fields. For each viewer, a vector is generated indicating that viewer's affinity with respect to the same set of creative fields. For a given viewer, a respective creator score is calculated based upon the vector associated with the viewer and the vector associated with that creator (e.g., based on a vector similarity computation). A ranking of each creator for the given viewer is then performed using the respective score, and a set of one or more personalized recommendations is then provided to the viewer based upon the ranking.

### FIELD OF THE DISCLOSURE

This disclosure relates to techniques for providing automatic recommendations to users of a content sharing network or creative platform for publishing and viewing creative works, and more particularly, for providing automatic recommendations of content creators to content viewers on a content sharing network by which viewers may view works created by creators.

### BACKGROUND

For artists and other content creators, the Internet serves as a powerful vehicle for sharing, obtaining recognition, and marketing and monetization of their projects or creative works. In general, a creative work may include any type of content that can be captured or otherwise represented in the digital or electronic domain, including textual content, graphical content, image content, video content, audio content, or any combination thereof (sometimes called rich media). A creative content platform allows creators to deposit, display, and broadcast their creative works to any number of users of the creative platform who may be interested in viewing and/or consuming creative works. For example, Behance®, which is a leading online platform to showcase and discover creative work, allows the creative world to update work in one place and to broadcast it widely and efficiently. Thereby, interested consumers of creative works may utilize a creative given platform to “follow” or otherwise access talent on a global scale.

Users of a creative platform may be creators, viewers, or both. As used herein, creators create or promote creative works and store them on a creative platform, where they are made available for viewing, purchasing, review, etc. Viewers are users of the creative platform who are seeking creative works and thus desire to view, review and comment on, download and/or purchase works of creators. Typically, creators desire to broadcast their work to as many relevant viewers as possible. Conversely, viewers desire to be presented only those creative works that are relevant to their tastes and preferences. One of the primary ways of discovering new creative work on a given creative platform is to allow users to “follow” particular creators. However, currently, existing creative platforms only suggest a universal list of creators to follow, which is not personalized to any particular user. Moreover, such generalized recommendations do not take into account the fact that a given creator may work in multiple fields, and that a given viewer may only be interested in works of that creator in one particular field.

In more detail, although creators may create projects or works across a wide array of fields in which creators may be active and viewers may hold interest, existing recommendation systems are incapable of leveraging this range of fields in providing recommendations. Further, creators and viewers engage with a creative platform in a dynamic manner over time. Such issues are particularly unique to the digital domain, which moves in a staggeringly different manner than the physical world. For instance, while a viewer may have a relatively limited opportunity to engage directly with a given creator in the physical world (e.g., perhaps a few physical exhibits, in a given lifetime), a viewer's access to a creator online digital works can be effectively unlimited. Moreover, creators of digital works tend to be more prolific. In any case, existing methods cannot account for or otherwise scale with these dynamics attributable to online content and thereby cannot provide as accurate and relevant recommendations of creators to viewers as would be desired.

Given that there are many different genres of creative projects on a creative platform, there exists no mechanism for viewers to be provided a personalized ranking of the creators the viewers might desire to follow. As noted above, this problem is particularly poignant in the digital domain, given the ubiquitous nature and availability of online information in general. In the case of online creative works, for instance, viewers can easily be overwhelmed with creative works that are not relevant to their particular interests. In contrast, viewers in the physical world are for the most part in control of the creative works to which they are exposed. In short, while currently available technology has provided accessibility to massive amounts of creative works, that accessibility is virtually constrained by a lack of technology capable of filtering those works for relevance so as to provide more meaningful and actionable information in a timely fashion that a viewer or creator can use. The inability to generate and disseminate personalized creator rankings to users of a creative platform tends to inhibit users from enjoying maximum value from that creative platform, thereby reducing the potential revenue of the platform. Further, lack of personalized recommendations limits the exposure of creators to optimal viewers (some interested users might not be reached while other viewers might be targeted whom are not appropriate). Thus, it is desirable that a creative platform provide for personalized recommendations of creators to other users of the platform.

### BRIEF DESCRIPTION OF THE DRAWINGS

FIG. 1a is a flowchart depicting a method for providing personalized creator recommendations to viewers according to one embodiment of the present disclosure.

FIG. 1b is a flowchart depicting an operation of a creator/viewer recommendation engine in performing a personalized creator recommendation update for at least one viewer, according to one embodiment of the present disclosure.

FIG. 2a depicts an example schema that may be utilized by a content interaction database, according to one embodiment of the present disclosure.

FIG. 2b depicts creators and viewers interacting with a creative platform configured according to an embodiment of the present disclosure.

FIG. 3a is a block diagram of a personalized creator/viewer recommendation engine configured according to one embodiment of the present disclosure.

FIG. 3b is a block diagram depicting calculation of a creative capital metric (“CCM”) carried out by a creator analytics engine of the personalized creator/viewer recommendation engine shown in FIG. 3a, according to one embodiment of the present disclosure.

FIG. 3c is a block diagram depicting calculation of an affinity metric (“AM”) carried out by a viewer analytics engine of the personalized creator/viewer recommendation engine shown in FIG. 3a, according to one embodiment of the present disclosure.

FIG. 3d is a block diagram depicting calculation of a personalized creator rating carried out by a creator/viewer analytics engine of the personalized creator/viewer recommendation engine shown in FIG. 3a, according to one embodiment of the present disclosure.

FIG. 3e depicts an example creator recommendation output by the personalized creator/viewer recommendation engine shown in FIG. 3a, according to one embodiment of the present disclosure.

FIG. 4a is an example plot of an evolution of a creative capital metric as a function of time, according to one embodiment of the present disclosure.

FIG. 4b is an example plot of a creative capital metric and a number of followers to illustrate their co-varying nature, according to one embodiment of the present disclosure.

FIG. 5a illustrates an example computing system that executes a personalized creator recommendation system configured in accordance with an embodiment of the present disclosure.

FIG. 5b illustrates an example integration of a personalized creator recommendation system into a network environment, according to another embodiment of the present disclosure.

### DETAILED DESCRIPTION

Techniques are disclosed for providing automatic recommendations of content creators to content viewers on a content sharing network by which viewers may view works created by creators. According to one embodiment, users of a given creative platform are provided with personalized recommendations for creators they may desire to follow on the given creative platform. A personalized recommendation list of creators may be provided to each user interacting with the creative platform so that a user is exposed to and can therefore engage with relevant creators and their associated work. Personalized recommendations of creators available on the given creative platform increases user engagement, user interaction, retention, and ultimately monetization.

According to one embodiment, a creator/viewer recommendation engine tracks project creation across a wide range of fields and genres and associated viewer interest in particular projects based upon those fields. Further, the creator/viewer recommendation engine generates personalized recommendations to viewers based upon underlying dynamics of creator and viewer interaction with a creative platform. Both the utilization of the field information and underlying dynamics facilitates providing more relevant/meaningful and timelier personalized creator recommendations to viewers.

In order to provide personalized recommendations, each creator is associated with a customized and unique vector herein referred to as a creative capital vector (“CCV”) (described in detail below), according to some embodiments. Each component of a CCV is a metric referred to herein as a creative capital metric (“CCM”) (described in detail below). A CCM selectively measures a creative output of a creator with respect to a particular creative field. Creative output can be measured based on factors such as the number of new projects created by that creator, the number of appreciations of all the creator's projects, the number of views of all projects of the creator, and the total number of exposures received by the creator in a given time period. A creative field refers to a genre or area in which a creator may be active in generating projects (or previously generated projects, as the case may be). Example creative fields may include but are not limited to Academia, Animation, Blogging, Caricature, Fiction, Non-Fiction, and Graphic Art, to name a few example fields. Each such creative field is in turn associated with a corresponding CCM of the corresponding CCV for the given creator. As will be appreciated in light of this disclosure, a given creator may work in one or more creative fields wherein each such creative field may be represented as a CCM component in a CCV associated with that particular creator. Thus, the CCV is specifically crafted to represent the creative output of a given creator with respect to one or more creative fields. Each of the CCV and CCM will be described in further detail below with illustrative examples.

Each viewer is associated with a customized and unique vector herein referred to as an affinity vector (“AV”) (described in detail below). Each component of an AV is a metric referred to herein as an affinity metric (“AM”) (described in detail below). An AM selectively measures a viewer's affinity toward a specific creative field. A viewer's affinity for a given creative field can be measured based on factors such as a number of projects appreciated by the viewer, a number of projects viewed by the viewer, and a number of projects to which the viewer has been exposed to over a predetermined time period. Each such creative field is in turn associated with a corresponding AM of the corresponding AV. As will be further appreciated in light of this disclosure, a given viewer may have an affinity toward one or more creative fields wherein each such creative field is represented as an AM component in the AV associated with that particular viewer. Thus, the AV is specifically crafted to represent a given viewer's affinity toward one or more creative fields, and by extension to represent that viewer's affinity to creators whom are active in those one or more fields. Each of the AV and AM will be described in detail below with illustrative examples.

According to one embodiment, personalized creator recommendations for a given viewer are generated by calculating a score for each creator with respect to the viewer, wherein the score is based on the respective CCV and AV of the viewer and creator. The recommendations can be presented to the user, for example, in the form of a list of ranked creators. Related information (such as link to creator bio, link(s) to published creative work, and a “follow” icon) can be provided, for example, in response to the user clicking on or otherwise selecting a given creator on the list. Example methods for generating a scored based upon a CCV and AV are described in detail below.

As will be appreciated in light of this disclosure, the creative capital vector (CCV) of the creator and the affinity vector (AV) of the viewer are generally referred to as vectors. In general, the creative capital vectors and affinity vectors as used herein can be any mathematical (digital) representation indicative of a set of attributes of interest, and more particularly that allow for measuring or otherwise qualifying the affinity of a given viewer (AV) to a given creator (CCV). The vectors may be used directly or in directly, in computing such affinities, as will be appreciated.

For instance, as previously explained, the CCV represents the creative output of a creator with respect to one or more creative fields, and the AV correspondingly represents a viewer's affinity toward a specific creative field. In some embodiments, the similarity or score for a given CCV/AV pair can be a direct measurement, such as dot product, cosine similarity or Pearson Correlation Coefficient. Vector is a convenient data structure to store the CCV and AV information, as well as, to compute the similarity or compatibilities between such information. However, one can also store the same information in other forms, such as hashtables, where the keys are the creative fields (or more generally, dimensions or categories) and the values are the CCM or AM for the corresponding creative field. In any such cases, and as will be appreciated, the score-based customized recommendations account for creator and viewer activity across an arbitrary range of fields, and further accounts for the dynamics of both creator and viewer interaction with a creative platform. The result is more relevant and accurate creator recommendations.

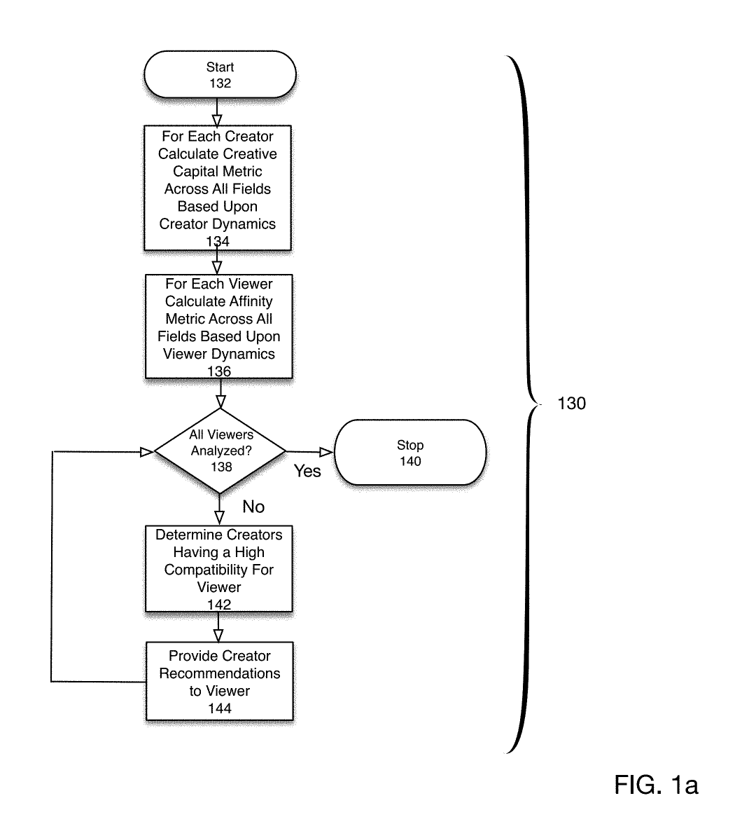

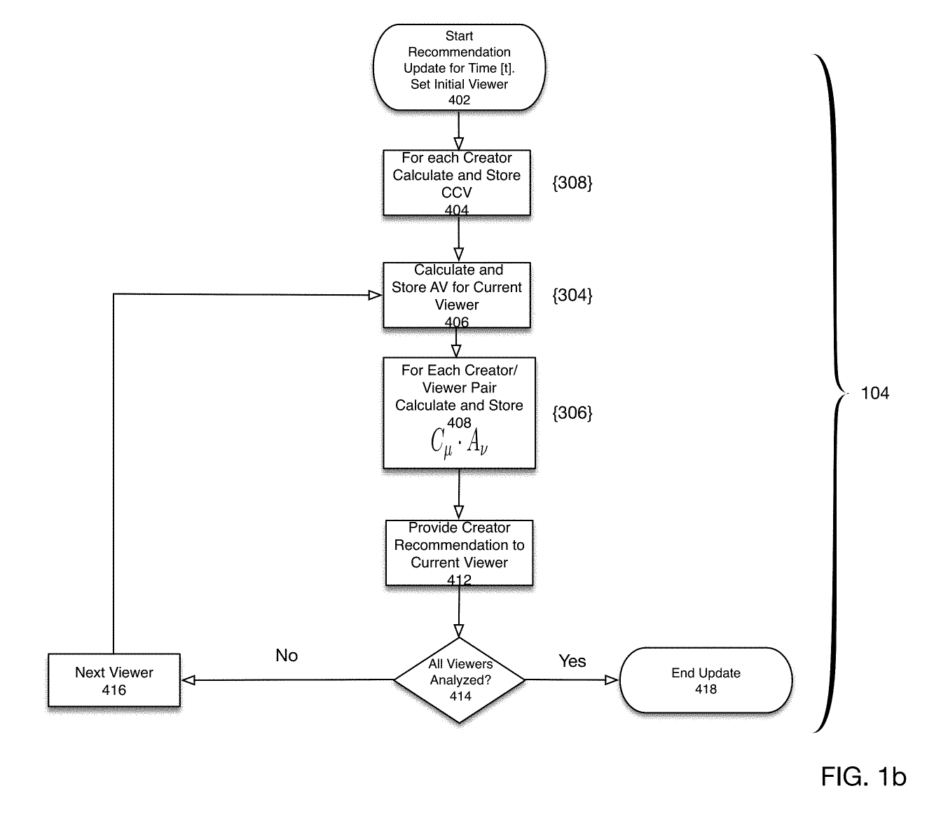

FIG. 1a is a flowchart depicting a method for providing personalized creator recommendations to viewers according to one embodiment of the present disclosure. A personalized recommendation process 130 shown in FIG. 1a accounts for creator and viewer activity across an arbitrary range of fields as well as the dynamics of both creator and viewer interaction with a creative platform facilitating the generation of more relevant and accurate creator recommendations. It is assumed for purposes of this discussion that the process shown in FIG. 1a is performed with respect to a set of creators and viewers that interact with a creative platform.

Process 130 is initiated in 132. In 134, a creative capital metric is determined for each creator across a plurality of fields. Examples of creative capital metrics are described below. For now, it is sufficient to understand that a creative capital metric embodies a measurement of a creator's aggregate capital with viewers with respect to a plurality of fields. Further, according to various embodiments described herein, a creative capital metric for each creator may be calculated dynamically based upon one or more attributes of a creator's interaction with a creative platform. Examples of dynamical attributes may include a decay attribute codifying the temporal relevance of more recent contributions as compared with older ones, exposures of a creator to viewers, etc. Specific examples of particular dynamical attributes that may be utilized in calculating a creative capital are described below. The dynamical nature of the calculation of a creative capital metric allows providing of more relevant and meaningful and timelier creator recommendations to viewers.

In 136, an affinity metric is determined for each viewer across a plurality of fields. Examples of affinity metrics are described below. For now, it is sufficient to understand that an affinity metric embodies a measurement of a viewer's aggregate affinity with respect to a plurality of fields. Further, according to various embodiments described herein, an affinity metric for each viewer may be calculated dynamically based upon one or more attributes of a viewer's interaction with a creative platform. Examples of dynamical attributes may include a decay attribute codifying the temporal relevance of more recent views as compared with older ones, exposures of creators to a viewer, etc. Specific examples of particular dynamical attributes that may be used in calculating an affinity metric are described below. The dynamical nature of the calculation of an affinity metric allows providing of more relevant and meaningful and timelier creator recommendations to viewers.

In 138, it is determined whether all viewers have been analyzed. If so, (‘Yes’ branch of 138), the process ends in 140. If not (‘No’ branch of 138), flow continues with 142 in which a determination is made of creators having a high compatibility for a viewer. According to one embodiment, a determination of compatibility may be performed by utilizing a combination of creative capital metrics associated with respective fields and a combination of affinity metrics associated with respective fields. According to one embodiment, a compatibility metric may be calculated based upon a combination of creative capital metrics for various fields and affinity metrics for various fields. In 144, creator recommendations are provided to the viewer based upon the calculated compatibility metric. According to one embodiment, a creator recommendation may be provided to a viewer if respective compatibility metric exceeds a predetermined threshold. Flow then continues with 138.

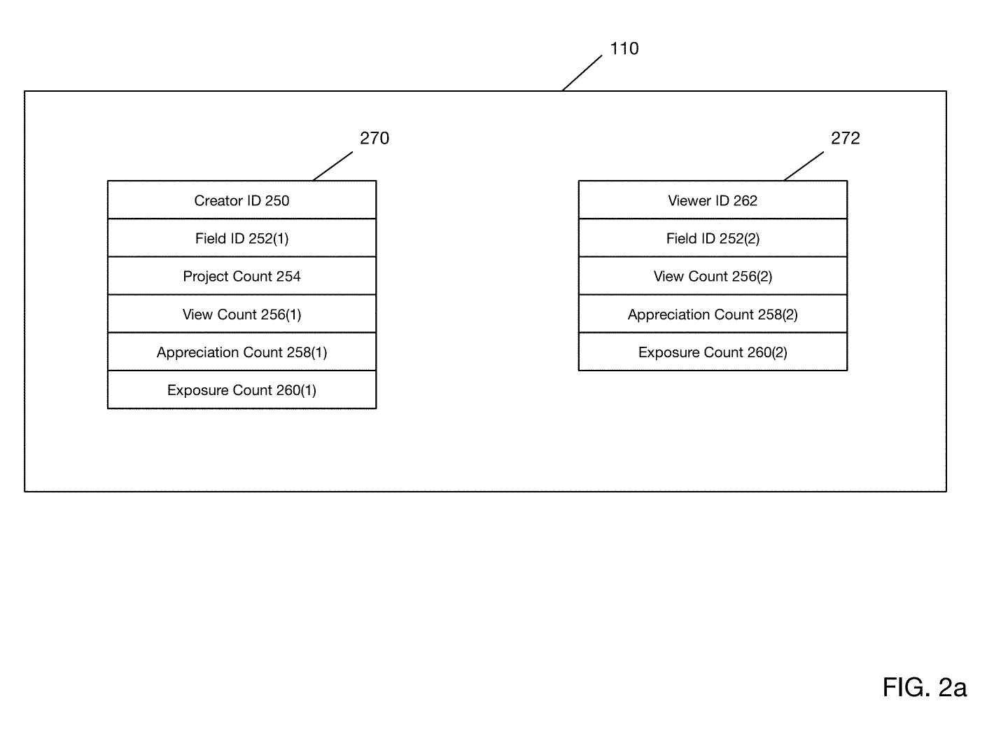

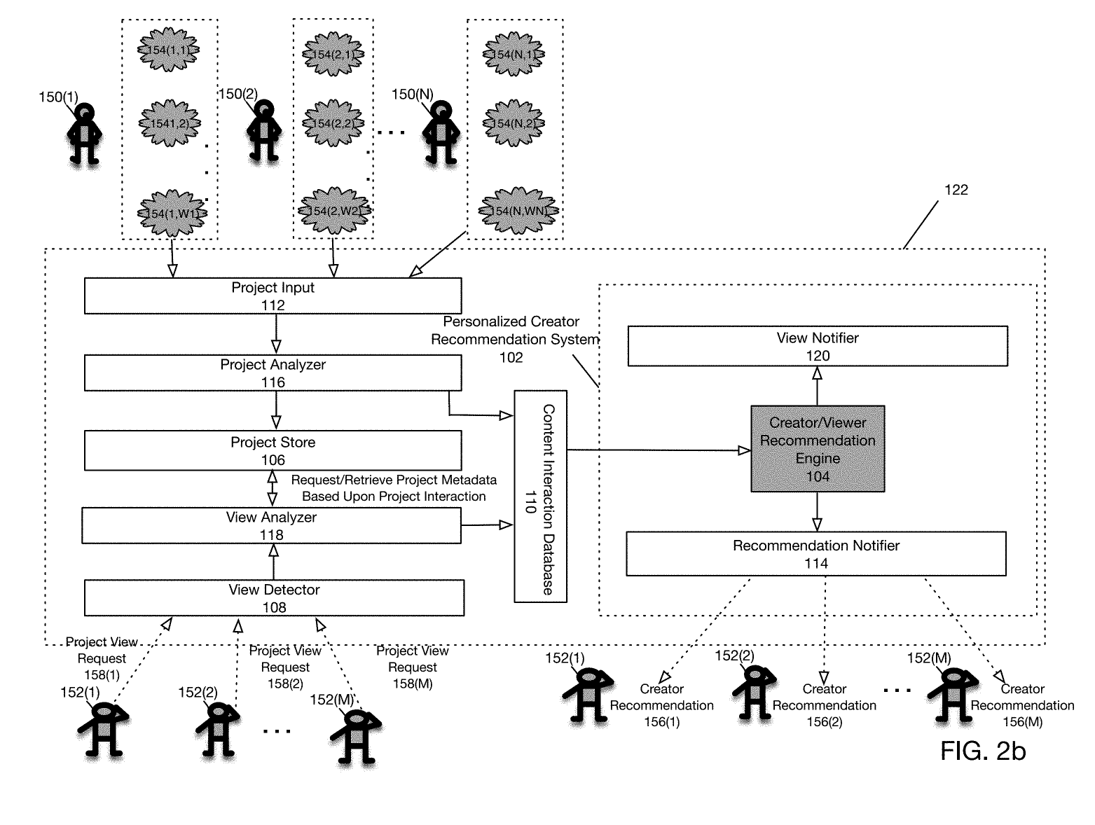

FIG. 1b is a flowchart depicting an operation of a creator/viewer recommendation engine in performing a personalized recommendation update for at least one viewer, according to one embodiment. The process depicted in FIG. 1b may be performed periodically at a pre-determined interval or time stamp [t]. It is assumed for purposes of discussion that at least one viewer and a plurality of creators interact with a creative platform (such as shown in FIG. 2b). Creators may generate projects in a variety of creative fields. A personalized recommendation, which in some embodiments comprises a list or set of one or more recommended creators for each viewer is generated and provided to a respective viewer.

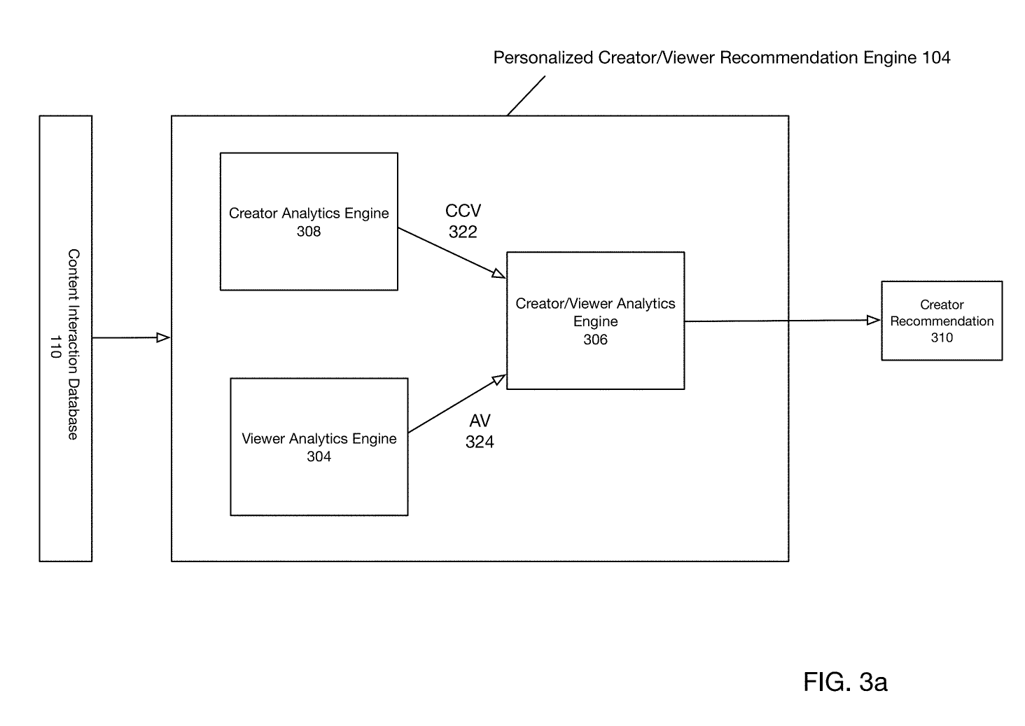

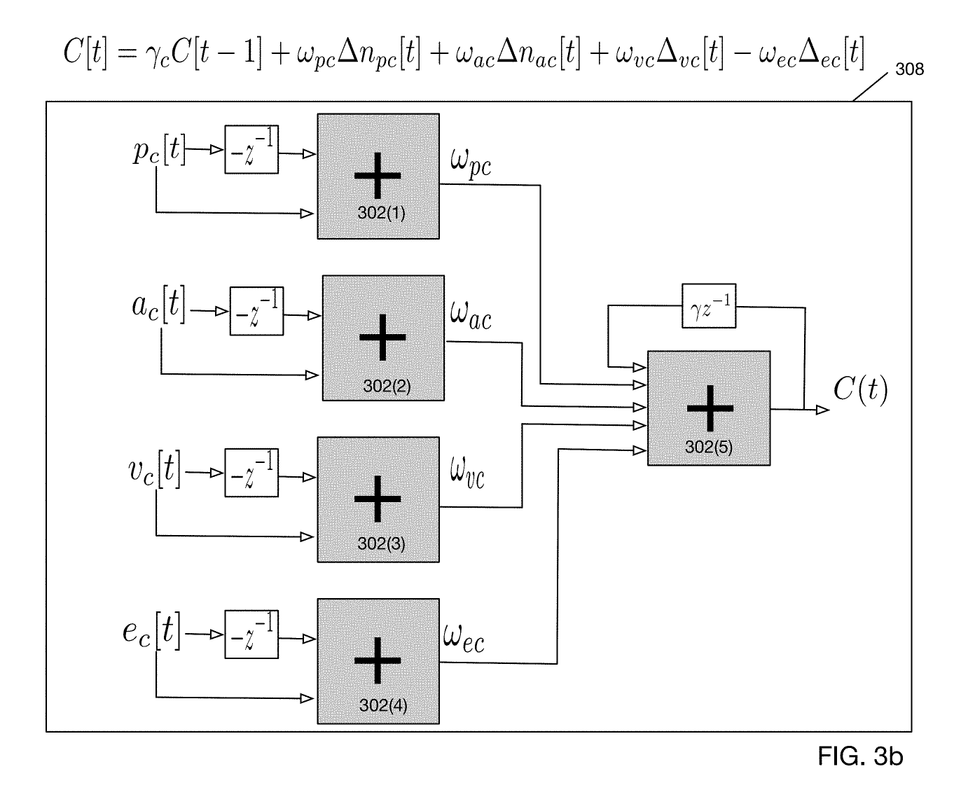

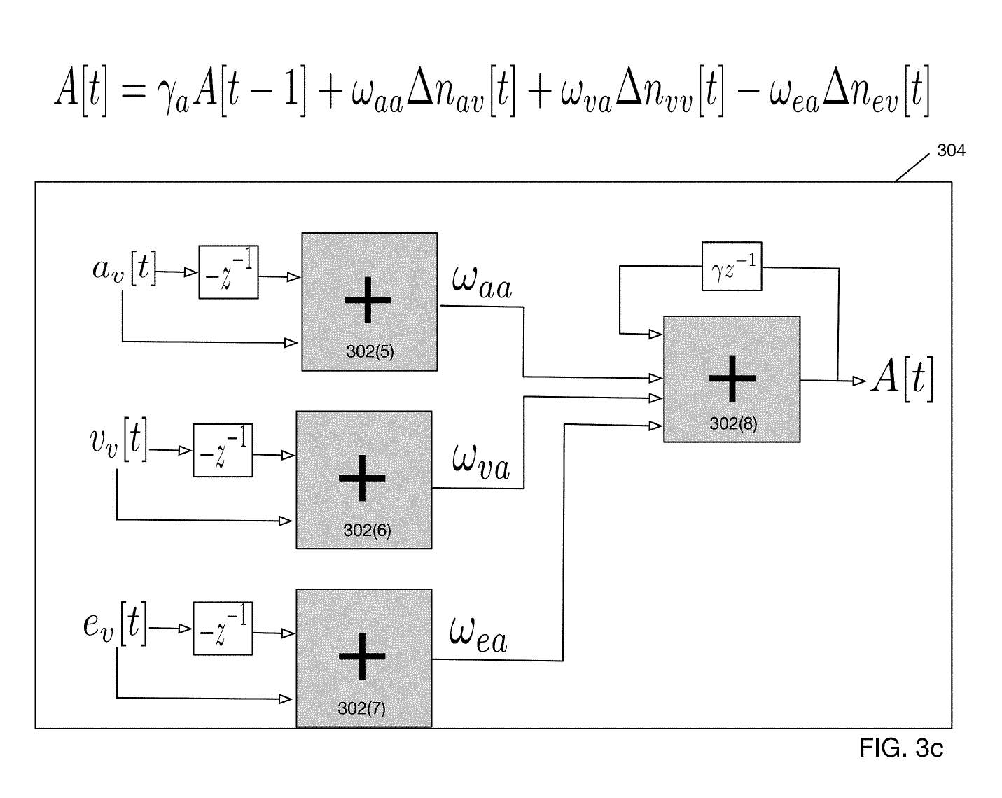

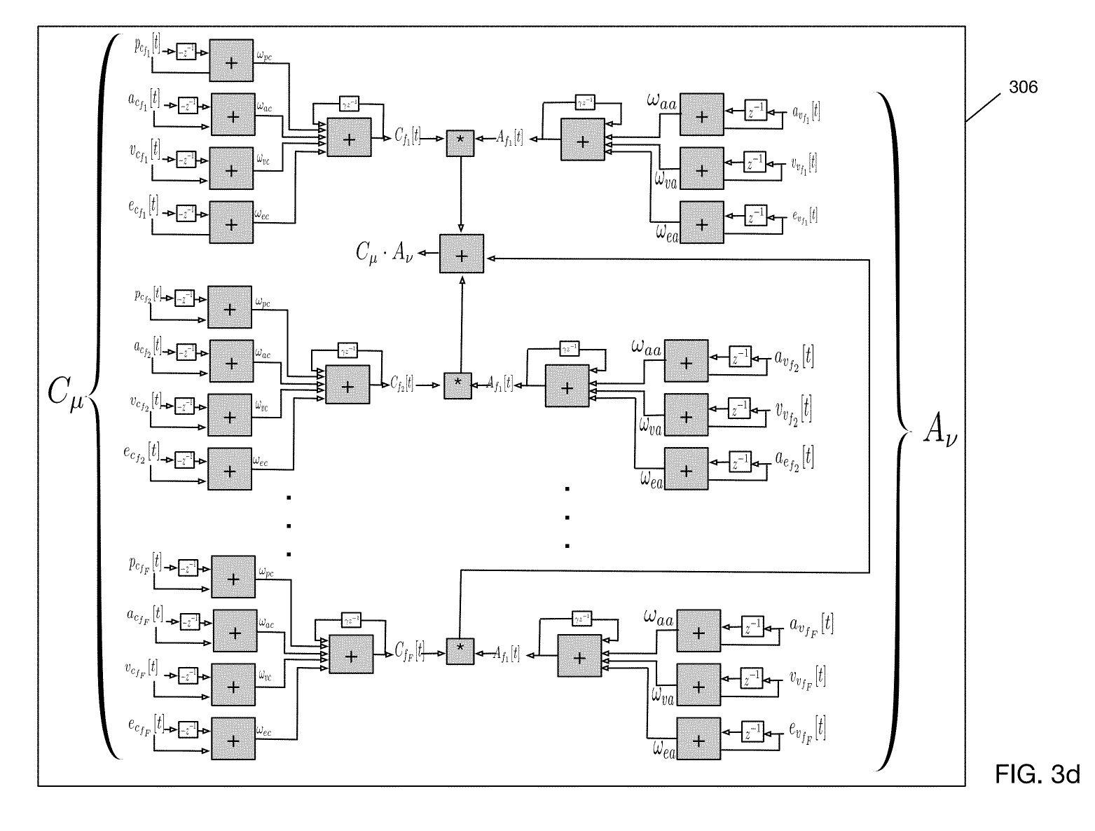

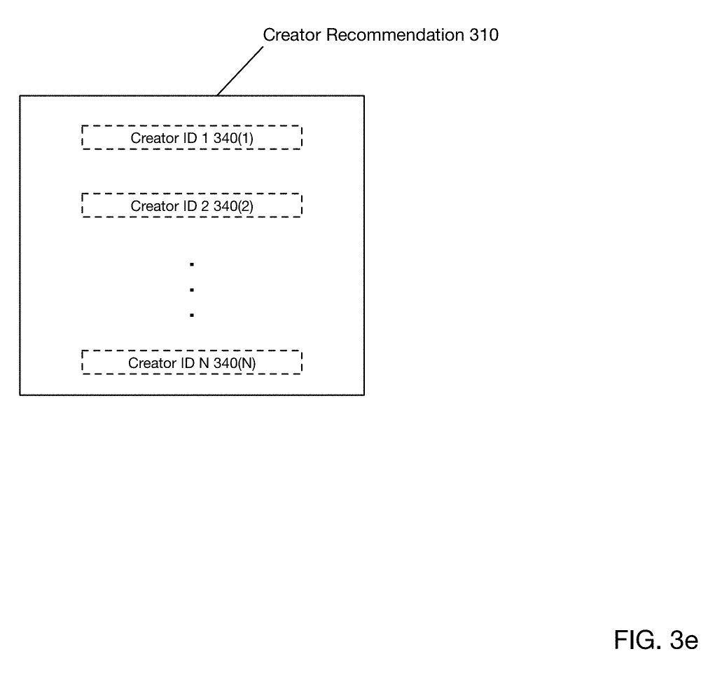

The process depicted in FIG. 1b may be performed, for example, by a personalized creator/viewer recommendation engine 104 accessible on a creative platform 122 (such as the example shown in FIGS. 2b and 3a), which is configured to generate a creator recommendation for each viewer. To assist in understanding, reference will also be made to components of engine 104 during the description of the process flow shown in FIG. 1b. As will be appreciated, the creative platform can be a cloud-based service that is accessible to a given viewer's computing system via a communication network (e.g., such as a local wireless network operatively coupled to the Internet or some other wide area network such as a campus-wide network). In such a client-server architecture, the creative platform may execute wholly on the client (viewer computing system) or wholly on the server (cloud-based service) or partly on the client and partly in the cloud. For instance, in one example case, a user interface of the creative platform can be downloaded to a browser executing on the viewer's computing system. The user interface can, among other things, allow access to the creative platform storage facility that includes creator works. A cloud-based server computing system can compute creator recommendations as variously described herein, and transmit those recommendations to the viewer via the user interface. Numerous platform configurations may be used to execute the process, as will be appreciated in light of this disclosure.

The process is commenced in 402 for time step [t] whereby an initial current viewer is selected or otherwise identified. The current viewer corresponds to the viewer for which a recommendation update is currently being generated. In 404, a creative capital vector (“CCV”) is generated and stored for all creators. In order to generate a CCV for each creator, a creative capital metric (“CCM”) is calculated for all creative fields in which a creator is active. For each creator, the calculated set of CCMs are assembled into a respective CCV such that the set of CCMs form the components or portions of the CCV. An example process for generating a CCV and CCM is described below with respect to FIG. 3b. As can be further seen in the example embodiment of FIG. 1, the step shown in 404 may be performed by a creator analytics engine 308 in a personalized creator/viewer recommendation engine 104 (described below with respect to the example embodiments shown in FIGS. 3a and 3b).

In 406, an affinity vector (“AV”) is calculated for the current viewer by calculating and storing an affinity metric (“AM”) for all fields associated with the current viewer and assembling the set of AMs as components of the AV. The step shown in 406 may be performed, for example, by a viewer analytics engine 304 in a personalized creator/viewer recommendation engine 104 (described below with respect to the example embodiments shown in FIGS. 3a and 3c).

In 408, a respective score is calculated for all creators with respect to the current viewer. The step shown in 408 may be performed by, for example, a creator/viewer analytics engine 306 in a personalized creator/viewer recommendation engine 104 (described below with respect to the example embodiments shown in FIGS. 3a and 3d). As will be described below, the score may be calculated using many different methods. In general, the score measures a similarity between the two vectors (creator's CCV and viewer's AV). The more similar the vectors, the more the interests of the current viewer are aligned with the creative work of a given creator, and the higher the score for that creator. Any number of techniques for determining the degree of compatibility or similarity between two vectors can be used, as will be appreciated. According to one example embodiment, the score for a creator with respect to a viewer is determined by calculating a dot product of the creator's CCV with the viewer's AV:

Rᵤᵥ=Cᵤ.Aᵥ

where Cᵤ represents the creator's CCV, Aᵥ represents the viewer's AV, and Rᵤᵥ is the dot product of the vectors CCV and AV and the score for the corresponding creator relative to the viewer. However, according to alternative embodiments, the score may be calculated using other methods.

In 412, based upon the scores calculated for all creators with respect to the current viewer, a creator recommendation (described in detail below with respect to FIG. 3e) is provided to the current viewer. According to one embodiment, a creator recommendation comprises a list of creators that are recommended for a viewer. Inclusion of a creator in a recommendation for a specific viewer may be determined based upon whether the score associated with that creator with respect to the viewer exceeds a predetermined value. For instance, in some embodiments, the list is ranked, from highest score to lowest score, for creators having a score above a given threshold. Creators having a score below the threshold may therefore be excluded from the list. The threshold or cut-off may be user-configurable or fixed. In still other embodiments, the threshold may be determined automatically in real-time after all scores have been computed, with the goal to provide a minimum number of recommended creators, regardless of any absolute threshold. In some such cases, the minimum number of recommended creators may be user-configurable or fixed. Numerous thresholding schemes can be used to generate the personalized list of one or more recommended creators. A personalized creator recommendation may be provided to a viewer via, for example, a client-side user interface of the creative platform, an email, an instant message, a voicemail or audio message, or other means suitable for communicating the recommendation to the viewer.

In 414, it is determined whether all viewers have been analyzed. If not, (‘No’ branch of 414), in 416, the current viewer is updated to the next viewer. Flow then continues with 406. If so (‘Yes’ branch of 414), the recommendation update ends in 418.

The process shown in FIG. 1b may be performed based upon an automatic or manual trigger. Triggers may include expiration of a timer (e.g., after a time step) or any other event (e.g., after an artist of interest posts a new creative work or updates a creative work, or after an artist within a field of interest receives a number of views above a given threshold or a number of viewer appreciations above a given threshold). As will be appreciated in light of this disclosure, such triggers allow for real-time updates to a recommendation at appropriate times when new relevant data becomes available. In some embodiments, the triggers may be user-configurable (by a user interface available to either the creator or the viewer, or both). In cases where both the creator and viewer have defined update triggers, the viewer can either allow or disallow recommendation updates based on update triggers set by the creator. Alternatively, the viewer will receive creator-triggered updates automatically, in addition to any recommendation updates triggered by the viewer's personal settings. In still other embodiments, only the creator is allowed to define the criterion that triggers a recommendation update relevant to that particular creator. In still other embodiments, the triggers may be hardcoded or otherwise non-configurable. Any number of other triggering schemes can be used, as will be further appreciated.

FIG. 2a depicts an example schema that may be utilized by a content interaction database according to one embodiment. Content interaction database 110 may be incorporated in a creative platform (described below with respect to FIG. 2b) and stores data relating to creator and viewer interaction with a creative platform. As can be seen, FIG. 2a shows creator-field table 270 and viewer-field table 272. Creator-field table 270 stores data relating to creator interaction with a creative platform. In this particular example embodiment, creator-field table 270 includes creator ID field 250, field ID field 252(1), project count field 254, view count field 256(1), appreciation count field 258(1), and exposure count field 260(1). Creator ID field 250 stores an identifier of a creator using a creative platform. Field ID field 252(1) stores an identifier of a field in which a creator may generate and submit projects to a creative platform. As previously explained, a creator may generate creative works in one or more fields. Thus, there can be a creator-field table 270 for each creative field in which a creator works. Project count field 254 stores an integer indicating a number of projects relating to field ID 252(1) and submitted by the creator having ID stored in creator ID field 250 to a creative platform. View count field 256(1) stores an integer representing a number of views a creator with ID stored in 250 has received for projects associated with the field stored in field ID 252(1). Appreciation count field 258(1) stores an integer representing a number of appreciations a creator has received for projects associated with the field associated with field ID 252. An appreciation generally refers to an indication by a viewer that a given creative work resonates with that viewer (i.e., the viewer likes or otherwise appreciates the work). Exposure count field 260(1) stores an integer representing a number of exposures of projects a creator with ID 250 has received for projects associated with the field ID 252(1). An exposure count generally refers to the number of people in an audience to which a given creative work was made available for viewing. In addition, according to some embodiments the exposure count will also take into account the position in which the relative position, in which a project was made available to a viewer. For example, more favorable (e.g., higher position in a list) position would correspond to higher level of exposure. Note that an exposure does not necessarily translate to a view, if a viewer doesn't click-through or otherwise actually view the creative work in question.

Viewer-field table 272 stores data relating to viewer interaction with a creative platform. In particular, viewer-field table 272 includes viewer ID field 262, field ID field 252(2), view count field 256(2), appreciation count field 258(2), and exposure count field 260(2). Viewer ID field 262 stores an identifier of a viewer using a creative platform. Field ID field 252(2) stores an identifier of a field ID related to projects a viewer may view on a creative platform. Similar to a creator creating works in multiple fields, a viewer may view creative works in one or more fields. Thus, there can be a viewer-field table 272 for each creative field in which a viewer views creative works. View count field 256(2) stores an integer representing a number of views a viewer with ID stored in 262 has performed for projects associated with the field stored in field ID 252(2). Appreciation count field 258(2) stores an integer representing a number of appreciations a viewer has performed for projects associated with the field associated with field ID 252(2). Exposure count field 260(2) stores an integer representing a number of exposures of projects a viewer with ID 262 has received for projects associated with the field ID 252(2).

FIG. 2b is a block diagram of a creative platform 122 including a personalized creator recommendation system 102 according to one embodiment. As further shown in FIG. 2b, creative platform 122 further comprises project input block 112, project analyzer block 116, project store block 106, view detector block 108, view analyzer block 118, and content interaction database 110. Personalized creator recommendation system 102 comprises personalized creator/viewer recommendation engine 104, recommendation notifier block 114, and view notifier block 120. In general, personalized creator recommendation system 102 may be a process or set of processes that are executed on a computing platform which may include, for example, a client-server architecture or a stand-alone computing system, as previously explained. In any case, the process(es) can be executed by one or more processors, such as a general-purpose CPU of a given computing system and/or server. It should be understood that the structure shown in FIG. 2b is merely one example configuration, and according to alternative embodiments various functions of the respective blocks may be combined in different ways and/or various blocks may or may not be present and/or additional functional blocks may be supplemented.

FIG. 2b depicts creators 150(1)-150(N) and viewers 152(1)-152(M) interacting with creative platform 122. Although not depicted in FIG. 2b, it is understood that creators and viewers may interact with creative platform 122 over any type of public network such as the Internet and/or private network. Creators 150(1)-150(N) create respective creative works (generally, projects) and submit those projects to creative platform 122, which are received at project input block 112. For example, as shown in FIG. 2b, creator 150(1) creates projects 154(1,1)-154(1,W1), creator 150(2) creates projects 154(2,1)-154(2,W2) and creator 150(N) creates projects 154(N,1)-154(N,WN), which are received by project input block 112.

Projects received by project input block 112 are passed to project analyzer block 116. Project analyzer block 116 is programmed or otherwise configured to perform various analytics to determine the type of project provided by a creator, for example the creative field(s) associated with a particular project, creator ID, and project count. The creative field(s) associated with a project may be determined by manual input provided by a creator, wherein the creator explicitly specifies one or more creative fields, or by an automated method, for example analysis of a submitted project. Based upon this analysis, project analyzer block 116 may generate metadata output, which among other information may include the creative field or fields associated with a project, creator ID, and project count. Alternatively, or in addition, project metadata associated with a submitted project may be provided manually by a creator upon submitting a project. Uploaded projects may then be stored in project store 106 along with any metadata generated by project analyzer 116 such as one or more creative fields associated with the project, creator ID, and project count. The project store 106 may be any cloud-based storage or local storage facility.

In addition, project analyzer block 116 may update content interaction database 110 upon receiving projects from creators. For each field associated with a submitted project, project analyzer block 116 may increment project count field 254 in associated creator-field tables 270. Project analyzer block 116 may also increment view count field 256(1), appreciation count field 258(1), or exposure count field 260(1) depending upon whether a project submitted by a creator has respectively received a view, appreciation or exposure.

FIG. 2b also depicts viewers 152(1)-152(M) interacting with creative platform 122 thereby they may view, appreciate, or be exposed to particular projects created by creators 150(1)-150(N). As noted previously, creators may interact with creative site 122 by submitting projects (e.g., 154(1,1)-154(1,W1)) to creative platform 122.

Viewers 152(1)-152(M) may interact with content on creative platform 122 in many ways among which include viewing projects, appreciating projects and being exposed by creative platform 122 to projects. First, viewers may view projects associated with particular creators. In addition, viewers may explicitly indicate an appreciation for a project. An appreciation of a project signifies a viewer's explicit recognition of the merits of a project. On the other hand, creative platform 122 may expose one or more projects to a viewer based upon a determination that a specific project might be of interest to the viewer. Creative platform 122 may expose a viewer to a project by, for example, automatically generating and sending an email or other notification to a viewer. Other marketing or exposure campaign strategies can be used as well, and the present disclosure is not intended to be limited to any particular ones.

View detector 108 detects viewers' interactions with projects stored in project store 106 including views and appreciations performed by the viewers. View analyzer 118 analyzes the nature of a specific viewer interaction with a project, for example, determining the nature of the interaction (view, appreciation, and other detectable data). In addition, view analyzer 118 operates to retrieve metadata stored in project store 106 based upon viewer interaction. Metadata may include, for example, the field(s) associated with a specific project with which a viewer is interacting, the viewer ID, and the view count.

View analyzer 118 may then update content interaction database 110 based upon the viewer interaction. View analyzer 118 may perform the following updates of content interaction database 110 based upon viewer interaction with creative platform 122. If a viewer views a particular project, view analyzer 118 will increment view count 251(1) and 256(2) in creator-field-table 270 and viewer-field table 272 respectively corresponding to the creator/viewer performing the view and the associated field of the project viewed. If a viewer appreciates a particular project, view analyzer 118 will increment appreciation count 258(1) and 258(2) in creator-field-table 270 and viewer-field table 272 corresponding to the creator/viewer performing the appreciation and the associated field of the project viewed. Similarly, if a project has been exposed to a particular viewer, view analyzer will increment exposure count 260(1) and 260(2) in creator-field table 270 and viewer-field table 272 respectively corresponding to the creator/viewer for which a project was exposed.

FIG. 2b also shows personalized creator recommendation system 102 that further includes creator/viewer recommendation engine 104, view notifier 120, and recommendation notifier 114. According to one embodiment, creator/viewer recommendation engine 104 generates creator recommendations, e.g. 156(1)-156(M), which are provided to respective viewers 152(1)-152(M). An example format of a creator recommendation is described below with respect to FIG. 3e. As noted previously, according to one embodiment, personalized creator recommendation system 102 generates creator recommendations for a given viewer by calculating a score for each creator with respect to the viewer based on a respective CCV and AV of the viewer and creator. Generated creator recommendations 156(1)-156(M) are provided to recommendation notifier block 114, which generates an appropriate message such as an e-mail or instant message or a voicemail including the creator recommendation for transmission to an appropriate viewer (e.g., 152(1)-152(M)). View notifier 120 may provide notifications to creators (e.g., 150(1)-150(N)) that a particular project has been viewed by a viewer.

FIG. 3a is a block diagram of a personalized creator/viewer recommendation engine according to one embodiment. As depicted in FIG. 3a, creator/viewer recommendation engine 104 further comprises creator analytics engine 308, viewer analytics engine 304, and creator/viewer analytics engine 306. Creator analytics engine 308 may perform analytics on data received from content interaction database 110 to generate a CCV 322 (described below). Viewer analytics engine 304 may perform analytics on data received from content interaction database 110 to generate an AV 324 (described below).

CCV 322 and AV 324 are received at creator/viewer analytics engine 306. According to one embodiment, creator/viewer analytics engine 306 generates a score as a function of CCV 322 and AV 324 received from creator analytics engine 308 and viewer analytics engine 304 respectively. Based upon the computed score, creator/viewer analytics engine 306 generates one or more creator recommendations 310. According to one embodiment, creator recommendation 310 may be a ranked list of one or more creators to be recommended to a particular viewer.

Global Creative Capital Metric

FIG. 3b is a block diagram depicting calculation of a CCM according to one embodiment. As described below, a creative capital metric for each creator may be calculated dynamically based upon one or more attributes of a creator's interaction with a creative platform. This dynamical nature facilitates generation of more accurate and meaningful and timelier creator recommendations by capturing the relevance of the creative capital metric over time, in real-time. According to one embodiment, a global CCM of a creator at time step ‘t’ is defined as follows:

C[t]=γ_{c}.C[t−1]+ω_{pc}.Δn_{pc}[t]+ω_{ac}.Δn_{ac}[t]+ω_{vc}.Δn_{vc}[t]=ω_{ec}.Δn_{ec}[t]

As reflected in the above relationship, the creative capital C of a creator at time step [t] may be defined a function of a scaled version of the creative capital at time [t-1] and the capital earned and spent from [t-1] to [t]. As further shown in the above relationship, the creative capital at time [t-1] may be scaled by a parameter γ_{c}, which represents a decay parameter associated with creators. According to one embodiment, γ_{c} is less than 1 to penalize the creator as time progresses. Therefore, if a creator remains inactive, that creator's creative capital will decrease due to the temporal decay term.65 _{c} controls the fraction of capital the creator will lose from what that creator had at time [t-1]. This factor ensures that the creators who produce quality projects (in terms of views and appreciations) consistently have high creative capital. Among other benefits, this factor allows for consistently high creative capital, thereby resulting in more accurate and timelier recommendations of creators to viewers.

Regarding the capital earned and spent from [t-1] to [t], according to one embodiment, the capital earned by a creator within a given time increment may be determined based upon the number of new projects created by that creator (Δn_{pc}[t],), the number of appreciations of all the creator's projects (Δn_{ac}[t]), the number of views of all projects of the creator (Δn_{vc}[t]) and the total number of exposures received by the creator (Δn_{ec}[t]) in the time period [t-1]−[t]. According to one embodiment, Δn_{pc}[t], Δn_{ac}[t]Δn_{vc}[t], and Δn_{ec}[t]) may be weighted respectively by ω_{pc}, ω_{ac}, ω_{vc}, and ω_{ec} which are the weights of each project, appreciation, view and exposure.

According to one embodiment, the weights ω_{pc}, ω_{ac}, ω_{vc}, and ω_{ec} may be assigned based on domain knowledge. For example, according to one embodiment, the weights are defined in such a manner such that the total weights of all projects, all project views and all project appreciations are approximately equal. Using this method, in one particular embodiment, the values of the weights were determined as follows:

ω_{pc}=50, ω_{ac}=5, ω_{vc}=1

Further, according to one embodiment the creative capital is reduced by an amount based on the number of exposures received by the creator in a particular time period (ω_{ec}.Δn_{ec}[t]). This term ensures that a project, which is given a fair amount of exposure, but that fails to garner enough responses (in terms of views and appreciations) should lead to erosion of the creative capital. If a project receives view/appreciations due to this exposure, the increase in creative capital due to the views/appreciations would far outweigh the decrease in CC due to loss by way of exposures (as typically have ω_{ec}<<ω_{ac}, ω_{cx}).

Referring to FIG. 3b, signals p_{c}[t], a_{c}[t], v_{c}[t], and e_{c}[t] respectively correspond to the total number of projects created by a creator, the total number of appreciations for all projects of a creator, the total views of all projects of a creator and the total number of exposures of projects of the creator at time [t].

Each of signals p_{c}[t], a_{c}[t], v_{c}[t], and e_{c}[t] is provided to a respective delay block z⁻¹ and respective summation block 302(1)-302(4). Each respective summation block 301(1)-301(4) sums respective input signal p_{c}[t], a_{c}[t], v_{c}[t], and e_{c}[t] and respective delayed input signal p_{c}[t-1], a_{c}[t-1], v_{c}[t-1], and e_{c}[t-1] to generate a respective summed output (not shown in FIG. 3b). Each respective summed output is then multiplied by a respective weight ω_{pc}, ω_{ac}, ω_{vc}, and ω_{ec}, generating a respective weighted signal, that is provided to summation block 302(5).

Summation block 302(5) generates a summation of signals ω_{pc}.Δn_{pc}[t], ω_{ac}.Δn_{ac}[t], ω_{vc}.Δn_{vc}[t], and ω_{ec}.Δn_{ec}[t] as well as γ_{c}.C[t-1] to produce creative capital metric C[t].

Global Affinity Metric

FIG. 3c is a block diagram depicting calculation of an AM according to one embodiment. According to various embodiments described herein, an affinity metric for each viewer may be calculated dynamically based upon one or more attributes of a viewer's interaction with a creative platform. This dynamical nature facilitates generation of more accurate and meaningful and timelier creator recommendations by capturing the relevance of the affinity metric over time, and in real-time. A global AM of a creator at time step [t] may be defined as follows:

A[t]=γₐ.A[t-1]+ωₐₐ.Δnₐᵥ[t]+ωᵥₐ.Δnᵥᵥ[t]−ωₑₐ.Δnₑᵥ[t]

As reflected in the above relationship, an affinity (A) associated with a viewer at time step [t] may be defined as a function of a scaled version of the affinity at time [t-1] and the affinity earned and spent from [t-1] to [t]. As shown in the above relationship, the affinity at time [t-1] may be scaled by a parameter γₐ, which represents a decay parameter associated with viewers. According to one embodiment, γₐ is less than 1 to penalize the viewer as time progresses. Therefore, if a viewer remains inactive, that viewer's affinity will decrease due to the temporal decay term. γₐ controls the fraction of affinity the viewer will lose from what that viewer had at time [t-1]. According to one embodiment, γₐ is a decay term to account for decrease in affinity when a viewer stops appreciating or viewing projects.

Δnₐᵥ[t], Δnᵥᵥ[t] and Δnlₑᵥ[t] are a number of projects appreciated, a number of projects viewed by a viewer, and a number of projects to which the viewer has been exposed to over a predetermined time period between [t-1] and [t]. ωₐₐ, ωᵥₐ and ωₑₐ are respective weights associated with Δnₐᵥ[t], Δnᵥᵥ[t], and Δnₑᵥ[t].

Referring to FIG. 3c, signals aᵥ[t], vᵥ[t], and eᵥ[t] respectively correspond to the total number of appreciations performed by a viewer, the total views of all projects performed by the viewer and the total number of exposures of projects provided to the viewer at time [t].

Each of signals aᵥ[t], vᵥ[t], and eᵥ[t] is provided to a respective delay block z⁻¹ and respective summation block 302(5)-302(8). Each respective summation block 301(5)-301(7) sums respective input signal aᵥ[t], vᵥ[t], and eᵥ[t] and respective delayed input signal aᵥ [t-1], vᵥ[t-1], and eᵥ[t-1] to generate a respective summed output (not shown in FIG. 3c). Each respective summed output is then multiplied by a respective weight ωₐₐ, ωᵥₐ, and ωₑₐ, generating a respective weighted signal (not shown in FIG. 3c), that is provided to summation block 302(8).

Summation block 302(8) generates a summation of signals ωₐₐ.Δnₐᵥ[t], ωᵥₐ.Δnᵥᵥ[t] and ωₑₐ.Δnₑᵥ[t] as well as γₐ.Δ[t-1] to produce creative capital metric A[t].

CCM for a Field

According to one embodiment, a personalized rating may be generated for a creator with respect to a viewer. According to one embodiment, similar to the global CCM a CCM may be defined with respect to a particular field as follows:

C_{f}[t]=γ_{c}.C_{f}[t-1]+ω_{pc}.Δn_{pc}_{_{f}}[t]+ω_{ac}.Δn_{sc}_{_{f}}[t]+ω_{vc}.Δn_{vc}_{_{f}}[t]−ω_{ec}.Δn_{ec}_{_{f}}[t]

According to this relationship γ_{c}.C_{f}[t-1] is a decay term to account for decrease in creative capital of a creator over time with respect to a creative field, f. Further, the creative capital earned by a creator with respect to a given field within a given time increment may be defined as a function of the number of new projects in that field created by that creator (Δn_{pc}_{_{f}}[t]), the number of appreciations of all the creator's projects in that field (Δn_{pc}_{_{f}}[t]), the number of views of all projects of the creator (Δn_{vc}_{_{f}}[t]) and the total number of exposures received by the creator in that field (Δn_{ec}_{_{f}}[t]) in the time period [t-1]−[t]. According to one embodiment, Δn_{pc}_{_{f}}[t], Δn_{ac}_{_{f}}[t], Δn_{vc}_{_{f}}[t], Δn_{ec}_{_{f}}[t] and Δn_{ec}_{_{f}}[t] may be weighted respectively by ω_{pc}, ω_{ac}, ω_{vc}, and ω_{ec} which are the weights of each project, appreciation, view and exposure.

CCV

According to one embodiment, a CCV 322 may be generated by forming a vector with components comprising CCMs for reach respective field, as indicated here.

Cᵤ={C_{f}_{₁}, C_{f}_{₂}, . . . , C_{f}_{ₙ}}

As previously described, C_{f}_{₁}-C_{f}_{ₙ}are creative capital metrics for a plurality of fields for a particular creator.

AM for a Field

Similarly, for a viewer, an AM with respect to a particular creative field f may be defined as:

A_{f}[t]=γₐ.A_{f}[t-1]+ωₐₐ.Δnₐᵥ_{_{f}}[t]+ωᵥₐ.Δnᵥᵥ_{_{f}}[t]−ωₑₐ.Δnₑᵥ_{_{f}}[t]

According to this relationship, γₐ.Δ_{f}[t-1] is a decay term to account for decrease in affinity when a viewer stops appreciating or viewing the projects in a creative field, f Further, the affinity earned by a viewer with respect to a given field within a given time increment may be defined as a number of appreciations performed by a viewer of projects in a field (Δnₐᵥ_{_{f}}[t]), a number of views of all projects in a field performed by a viewer (Δnᵥᵥ_{_{f}}[t]) and the total number of exposures received by a viewer in a field (Δnₑᵥ_{_{f}}[t]) in the time period [t-1]−[t]. According to one embodiment, Δnₐᵥ_{_{f}}[t], Δnᵥᵥ_{_{f}}[t]Δnₑᵥ_{_{f}}[t] may be weighted respectively by ωₐₐ, ωᵥₐ and ωₑₐ, which are the weights of each appreciation, view and exposure.

Analogous to a CCV 322 defined above, an AV 324 for n creative fields {f1, f2, . . . , fn}, may be defined as follows:

Aᵥ={A_{f}_{₁}, A_{f}_{₂}, . . . , A_{f}_{ₙ}}

As previously described, A_{f}_{₁}-A_{f}_{ₙ} are affinity metrics for a plurality of fields for a particular viewer.

Personalized Rating

FIG. 3d is a block diagram depicting calculation of a personalized rating according to one embodiment. According to one embodiment, personalized creator recommendations for a given viewer are generated by calculating a score for each creator with respect to the viewer based on the respective CCV 322 and AV 324 of the creator and viewer. According to one example embodiment, the score may be calculated by forming a vector dot product between a CCV 322 and AV 324 as follows:

Rᵤᵥ=Cᵤ.Aᵥ

However, according to alternative embodiments, the score may be determined by alternative methods, for example, by calculating a cosine similarity or Pearson correlation coefficient, to name other example techniques for determining the degree of compatibility or similarity between two vectors. Any number of such vector-based mathematical operations can be used to generate a mathematical representation of a recommendation based on the CCV 322 and AV 324, as will be appreciated in light of this disclosure.

FIG. 3e depicts a creator recommendation according to one embodiment. Creator recommendation 310 may be generated by creator/viewer recommendation engine 104 (FIG. 3a). As shown in FIG. 3e, creator recommendation 310 may comprise a set of creator IDs 340(1)-340(N) indicating creators that are recommended to a particular viewer. According to one embodiment, creators may be recommended to a viewer if a score calculated from a CCV associated with a creator and AV associated with the viewer exceeds a predetermined threshold value.

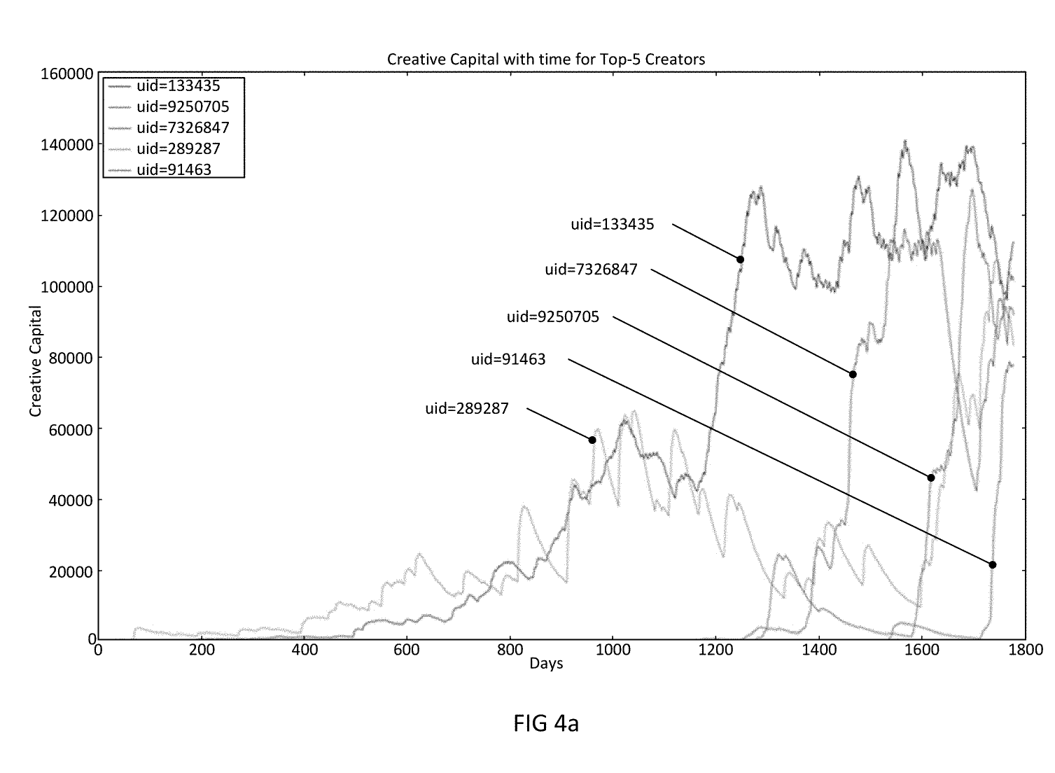

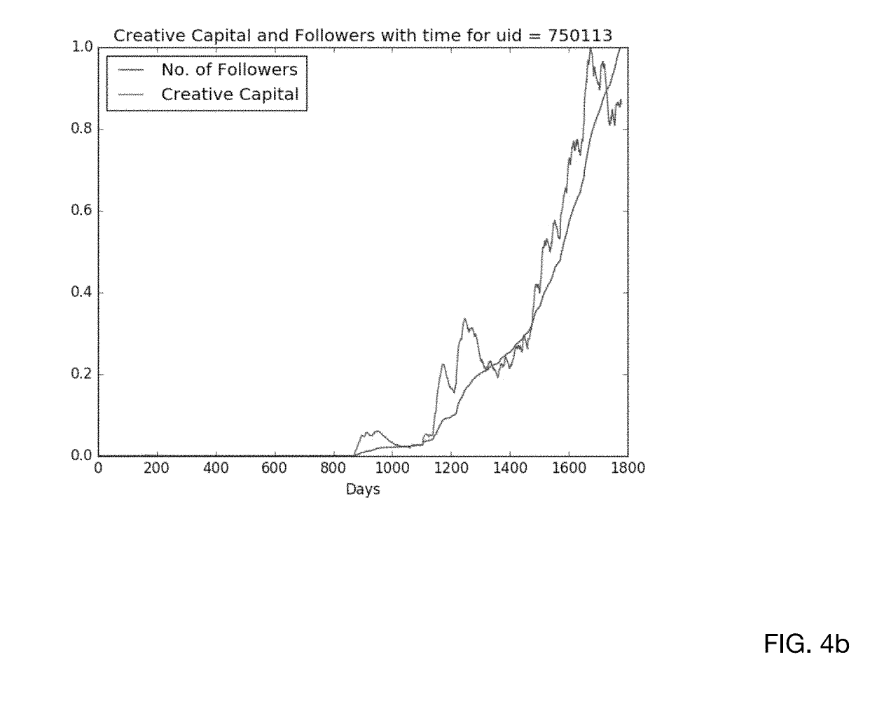

FIG. 4a is an example plot of an evolution of a creative capital metric as a function of time according to one embodiment. In particular, FIG. 4a shows a time evolution of creative capital for five (5) creators between 2011 and May 2016. The parameter setting for the data shown in FIG. 4a is as follows:

Reward for view received on a created project=1 unit;

Reward for appreciation received on a created project=5 units;

Reward for creating a project=50 units;

Decay factor/gamma=0.988; and

In case of jointly created project, credit is shared equally (1/n fraction for each, if n is the number of creators) between all creators.

A penalty for exposures that do not result in project views was not implemented in this example embodiment, but may be in other embodiments. Such a penalty can be used, for instance, to ensure that posting a lot of projects (spamming) would not result in giving high rank to spammers. Note that a spammer may be the creator, but may also be a third-party service that attempts to increase a given creator's standing on a given platform by using a broad exposure campaign. In any such cases, a viewing threshold can be set and used to trigger the penalty. For example, according to one embodiment, if less than 25% of exposures result in a project view, then the exposure number can be prorated downward or otherwise diminished in its relevance in favorably impacting the creator's ranking. Also, the projects that are not found to be interesting by the viewers can quickly be identified and their contribution to the creative capital can be marginalized or otherwise made negligible. Numerous such manipulations can be used to diminish or offset the value of ‘empty’ activity that bears no fruit (where viewers are not really responding in a favorable way despite considerable efforts by the creator or agents of the creator).

FIG. 4b is an example plot of a creative capital metric and a number of followers to illustrate their co-varying nature according to one embodiment. As shown in FIG. 4b, the number of followers correlates with the value of the creative capital score. If a viewer “follows” a given creator, for instance, that viewer may receive a feed or notifications about activity associated with that that creator. Thus, for example, the viewer can be kept current on any new projects that are published by the creator. As will be appreciated, a “follow” is distinct from a so-called “appreciate” or “like” or “share” all of which tend to be specific to a given work. In this manner, a follow indicates a higher level of engagement than other engagement metrics. The specific definition of “follow” may vary from one embodiment to the next, but the general concept of a viewer expressing broad interest in the works and activities of a given creator is present in all such definitions, and the present disclosure is intended to cover all such definitions, as will be appreciated.

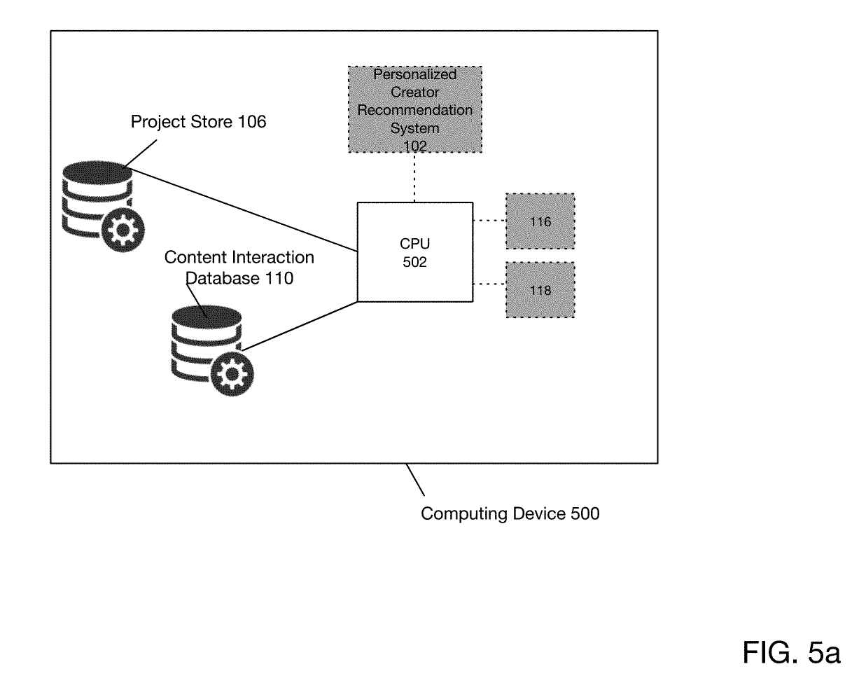

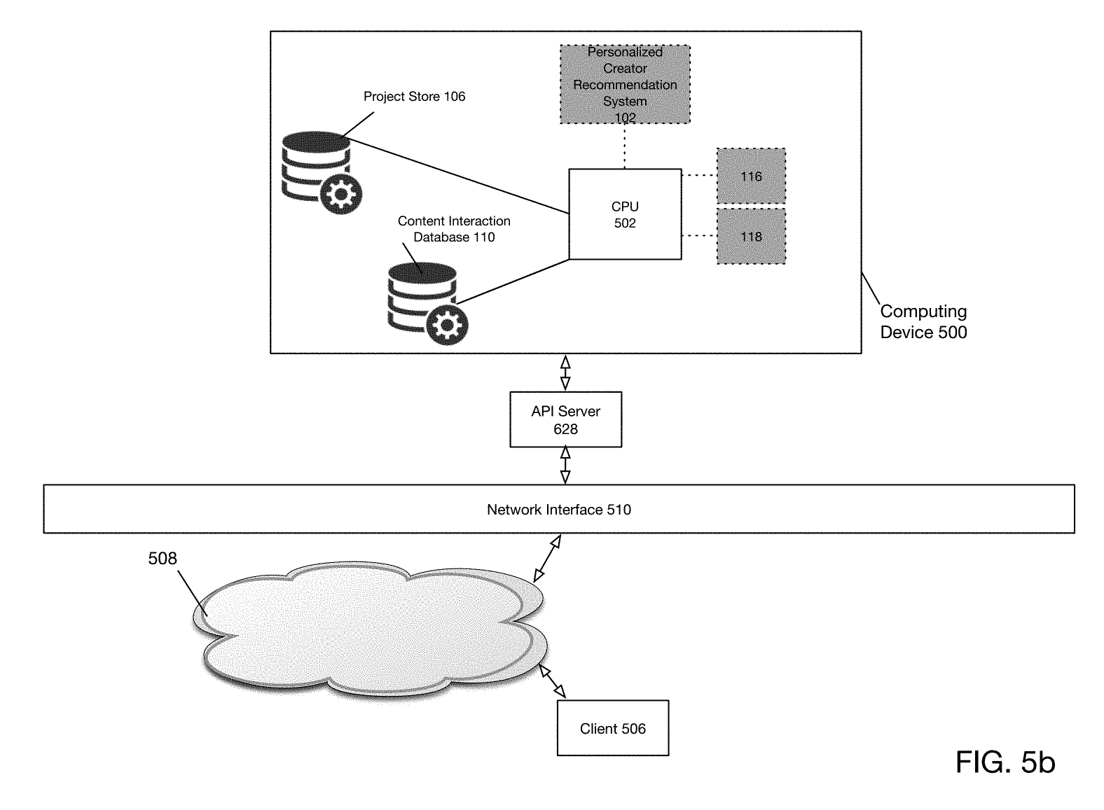

FIG. 5a illustrates an example computing system that executes a personalized creator recommendation system in accordance with an embodiment of the present disclosure. As depicted in FIG. 5a, computing device 500 includes project store 106, content interaction database 110, and CPU 502. CPU 502 is configured via programmatic instructions to execute project analyzer 116 and view analyzer 118 (as variously described herein, such as with respect to FIG. 2b). CPU 502 is further configured via programmatic instructions to execute personalized creator recommendation system 102 (as variously described herein, such as with respect to FIG. 2b). Other componentry and modules typical of a typical computing system, such as, for example a co-processor, a processing core, a graphics processing unit, a mouse, a touch pad, a touch screen, display, etc., are not shown but will be readily apparent. Numerous computing environment variations will be apparent in light of this disclosure. For instance, project store 106 may be external to the computing device 500. Device 500 can be any stand-alone computing platform, such as a desk top or work station computer, laptop computer, tablet computer, smart phone or personal digital assistant, game console, set-top box, or other suitable computing platform.

FIG. 5b illustrates an example integration of a personalized creator recommendation system into a network environment, according to another embodiment of the present disclosure. As depicted in FIG. 5b, computing device 500 may be co-located in a networked arrangement or so-called cloud environment, data center, local area network (“LAN”) etc. Computing device 500 shown in FIG. 5b is similar to the example embodiment described with respect to FIG. 5a, but is implemented as a server computer rather than a stand-alone computing system. As shown in FIG. 5b, client 506 interacts with personalized creator recommendation system 102 executing on or otherwise made accessible by computing device 500 via network 508. In particular, client 506 may make requests and receive responses from personalized creator recommendation system 102 via API calls received at API server 628, which are transmitted via network 508 and network interface 510. As will be appreciated in light of this disclosure, any number of request-response schemes can be implemented here, and the present disclosure is not intended to be limited to any particular ones.

It will be further readily understood that network 508 may comprise any type of public and/or private network including the Internet, LANs, WAN, or some combination of such networks. In this example case, computing device 500 is a server computer, and client 506 can be any typical personal computing platform. Further note that some components of the creator recommendation system 102 may be served to and executed on the client 506, such as a user interface by which a given user interacts with the system 102. The user interface can be configured, for instance, similar to the user interface of Behance® in some embodiments. In a more general sense, the user interface may be configured, for instance, to allow users to search for and view creative works, and to follow or appreciate certain creators for which the viewer has affinity. The user interface can be thought of as the front-end of the creative platform. The user interface may further be configured to cause display of an output showing ranked creators, such as shown in FIG. 3e. Other so-called back-end components of system 102 can be executed on the server device 500 in some such embodiments. Any number of client-server schemes can be used.

As will be further appreciated, computing device 500, whether the one shown in FIG. 5a or 5b, includes and/or otherwise has access to one or more non-transitory computer-readable media or storage devices having encoded thereon one or more computer-executable instructions or software for implementing techniques as variously described in this disclosure (such as instructions encoding the various modules or components of creative platform 122). The storage devices may include any number of durable storage devices (e.g., any electronic, optical, and/or magnetic storage device, including RAM, ROM, Flash, USB drive, on-board CPU cache, hard-drive, server storage, magnetic tape, CD-ROM, or other physical computer readable storage media, for storing data and computer-readable instructions and/or software that implement various embodiments provided herein. Any combination of memories can be used, and the various storage components may be located in a single computing device or distributed across multiple computing devices. In addition, and as previously explained, the one or more storage devices may be provided separately or remotely from the one or more computing devices. Numerous configurations are possible.

In some example embodiments of the present disclosure, the various functional modules and components of creative platform 122 and specifically personalized creator recommendation system 122, may be implemented in software, such as a set of instructions (e.g., HTML, XML, C, C++, object-oriented C, JavaScript, Java, BASIC, etc.) encoded on any non-transitory computer readable medium or computer program product (e.g., hard drive, server, disc, or other suitable non-transitory memory or set of memories), that when executed by one or more processors, cause the various creator recommendation methodologies provided herein to be carried out.

In still other embodiments, the techniques provided herein are implemented using software-based engines. In such embodiments, an engine is a functional unit including one or more processors programmed or otherwise configured with instructions encoding a creator recommendation process as variously provided herein. In this way, a software-based engine is a functional circuit.

In still other embodiments, the techniques provided herein are implemented with hardware circuits, such as gate level logic (FPGA) or a purpose-built semiconductor (e.g., application specific integrated circuit, or ASIC). Still other embodiments are implemented with a microcontroller having a processor, a number of input/output ports for receiving and outputting data, and a number of embedded routines by the processor for carrying out the functionality provided herein. In a more general sense, any suitable combination of hardware, software, and firmware can be used, as will be apparent. As used herein, a circuit is one or more physical components and is functional to carry out a task. For instance, a circuit may be one or more processors programmed or otherwise configured with a software module, or a logic-based hardware circuit that provides a set of outputs in response to a certain set of input stimuli. Numerous configurations will be apparent.

### FURTHER EXAMPLE EMBODIMENTS

The following examples pertain to further embodiments, from which numerous permutations and configurations will be apparent.

Example 1 is a computer-implemented method for providing recommendations of creators to a viewer in the context of a creative platform for publishing and viewing creative works, the method comprising: for each of a plurality of creators, generating a respective creative capital vector, said creative capital vector comprising at least one first component, each of said at least one first component associated with a respective creative capital metric for a respective creative field; for a viewer, generating a respective affinity vector, said affinity vector comprising at least one second component, each of said at least one second component associated with a respective affinity metric for a respective creative field; generating a respective personalized ranking of each of said plurality of creators for said viewer, based on a similarity between said creative capital vector and said affinity vector; and providing a recommendation of one or more of said plurality of creators to said viewer based upon said respective personalized ranking.

Example 2 includes the subject matter of Example 1, wherein the respective creative capital metric is a function of: time, a number of projects created by said respective creator, a number of appreciations of works of said respective creator, a number of views of works of said respective creator, and an exposure metric of said respective creator.

Example 3 includes the subject matter of Example 1 or 2, wherein said affinity metric is a function of: time, a number of appreciations of works of said viewer, a number of views of works of said viewer, and an exposure metric of said viewer.

Example 4 includes the subject matter of any of the preceding Examples, wherein providing a recommendation of one or more of said plurality of creators includes: identifying which of said creators has a rank above a pre-defined threshold, thereby identifying one more target creators; and providing a recommendation of the one or more target creators.

Example 5 includes the subject matter of Example 4, wherein said pre-defined threshold is user-configurable.

Example 6 includes the subject matter of any of the preceding Examples, wherein providing a recommendation of one or more of said plurality of creators includes: providing a suggestion to said viewer to follow one or more highly-ranked creators. Once the user opts to follow a given creator, the viewer may for instance receive notifications when that creator posts or otherwise published a new project or is otherwise involved in an activity monitored by the creative platform.

Example 7 includes the subject matter of Example 6, wherein providing a suggestion includes causing display of a user interface control label that is selectable so as to allow said viewer to follow a respective creator in the creative platform.

Example 8 is a system for providing recommendations of creators to viewers in the context of a creative platform for publishing and viewing creative works, said system comprising: a creator analytics engine, said creator analytics engine to receive creator interaction data and generate a creative capital vector (“CCV”) based on said creator interaction data; a viewer analytics engine, said viewer analytics engine to receive viewer interaction data and generate an affinity vector (“AV”) based on said viewer interaction data; and a creator/viewer analytics engine, said creator/viewer analytics engine to generate a score for a creator with respect to a creator based upon said CCV and said AV, wherein said creator/viewer analytics engine is further to provide a creator recommendation to a viewer based upon said score. Example creator interaction data and viewer interaction data are shown in FIG. 2a (270 is creator interaction data, and 272 is viewer interaction data), according to some embodiments of the present disclosure.

Example 9 includes the subject matter of Example 8, wherein said creator analytics engine is configured to generate said CCV by assembling a plurality of creative capital metrics (CCMs) as vector components, wherein each component corresponds to a CCM with respect to a particular field, and wherein a CCM is a measure of creative output of said creator with respect to that particular field.

Example 10 includes the subject matter of Example 8 or 9, wherein said viewer analytics engine is configured to generate said AV by assembling a plurality of affinity metrics (AMs) as vector components, wherein each component corresponds to an AM with respect to a particular field, and wherein an AM is a measure of said viewer's affinity toward that particular field.

Example 11 includes the subject matter of any of Examples 8 through 10, wherein said score is generated by forming a vector dot product of said CCV and said AV.

Example 12 includes the subject matter of any of Examples 8 through 11, wherein said creator/viewer analytics engine is configured to provide said creator recommendation to said viewer if said score exceeds a predetermined value.

Example 13 includes the subject matter of any of Examples 8 through 12, wherein said CCV is determined based upon at least one of a number of projects created by said creator, a number of views of projects of said creator, a number of appreciations of projects of said creator, and a number of exposures of projects of said creator.

Example 14 includes the subject matter of any of Examples 8 through 13, wherein said AV is determined based upon at least one of a number of views of projects performed by said viewer, a number of appreciations of projects, and a number of exposures of projects.

Example 15 is a computer program product including one or more non-transitory machine readable mediums encoded with instructions that when executed by one or more processors cause a process to be carried out for providing recommendations of creators to viewers in the context of a creative platform for publishing and viewing creative works, said process comprising: receiving creator interaction data and generating a creative capital vector (“CCV”) based on said creator interaction data; receiving viewer interaction data and generating an affinity vector (“AV”) based on said viewer interaction data; generating a score for a creator with respect to a creator based upon said CCV and said AV; and providing a creator recommendation to a viewer based upon said score. As previously explained, example creator interaction data 270 and viewer interaction data 272 are shown in FIG. 2a, according to some embodiments. The one or more non-transitory machine readable mediums may be any physical memory device, such as one or more computer hard-drives, servers, magnetic tape, compact discs, thumb drives, solid state drives, ROM, RAM, on-chip cache, registers, or any other suitable non-transitory or physical storage technology.

Example 16 includes the subject matter of Example 15, wherein said CCV is generated by assembling a plurality of creative capital metrics (CCMs) as vector components, wherein each component corresponds to a CCM with respect to a particular field, and wherein a CCM is a measure of creative output of said creator with respect to that particular field.

Example 17 includes the subject matter of Example 15 or 16, wherein said AV is generated by assembling a plurality of affinity metrics (AMs) as vector components, wherein each component corresponds to an AM with respect to a particular field, and wherein an AM is a measure of said viewer's affinity toward that particular field.

Example 18 includes the subject matter of any of Examples 15 through 17, wherein said score is generated by forming a vector dot product of said CCV and said AV.

Example 19 includes the subject matter of any of Examples 15 through 18, wherein said creator recommendation is provided to said viewer if said score exceeds a predetermined value.

Example 20 includes the subject matter of any of Examples 15 through 19, wherein said CCV is determined based upon at least one of a number of projects created by said creator, a number of views of projects of said creator, a number of appreciations of projects of said creator, and a number of exposures of projects of said creator, and wherein said AV is determined based upon at least one of a number of views of projects performed by said viewer, a number of appreciations of projects, and a number of exposures of projects.

The foregoing description of example embodiments of the disclosure has been presented for the purposes of illustration and description. It is not intended to be exhaustive or to limit the disclosure to the precise forms disclosed. Many modifications and variations are possible in light of this disclosure. It is intended that the scope of the disclosure be limited not by this detailed description, but rather by the claims appended hereto.

What is claimed is:

1. A computer-implemented method for providing recommendations of creators to a viewer in the context of a creative platform for publishing and viewing creative works, the method comprising:
for each of a plurality of creators, generating a respective creative capital vector, said creative capital vector comprising at least one first component, each of said at least one first component associated with a respective creative capital metric for a respective creative field;
for a viewer, generating a respective affinity vector, said affinity vector comprising at least one second component, each of said at least one second component associated with a respective affinity metric for a respective creative field;
generating a respective personalized ranking of each of said plurality of creators for said viewer, based on a similarity between said creative capital vector and said affinity vector; and
providing a recommendation of one or more of said plurality of creators to said viewer based upon said respective personalized ranking.

2. The method according to claim 1, wherein the respective creative capital metric is a function of: time, a number of projects created by said respective creator, a number of appreciations of works of said respective creator, a number of views of works of said respective creator, and an exposure metric of said respective creator.

3. The method according to claim 2, wherein said affinity metric is a function of: time, a number of appreciations of works of said viewer, a number of views of works of said viewer, and an exposure metric of said viewer.

4. The method according to claim 1, wherein providing a recommendation of one or more of said plurality of creators includes:
identifying which of said creators has a rank above a pre-defined threshold, thereby identifying one more target creators; and
providing a recommendation of the one or more target creators.

5. The method according to claim 4, wherein said pre-defined threshold is user-configurable.

6. The method according to claim 1, wherein providing a recommendation of one or more of said plurality of creators includes:
providing a suggestion to said viewer to follow one or more highly-ranked creators.

7. The method according to claim 6, wherein providing a suggestion includes causing display of a user interface control label that is selectable so as to allow said viewer to follow a respective creator in the creative platform.

8. A system for providing recommendations of creators to viewers in the context of a creative platform for publishing and viewing creative works, said system comprising:
a creator analytics engine, said creator analytics engine to receive creator interaction data and generate a creative capital vector (“CCV”) based on said creator interaction data;
a viewer analytics engine, said viewer analytics engine to receive viewer interaction data and generate an affinity vector (“AV”) based on said viewer interaction data; and
a creator/viewer analytics engine, said creator/viewer analytics engine to generate a score for a creator with respect to a creator based upon said CCV and said AV, wherein said creator/viewer analytics engine is further to provide a creator recommendation to a viewer based upon said score.

9. The system according to claim 8, wherein said creator analytics engine is configured to generate said CCV by assembling a plurality of creative capital metrics (CCMs) as vector components, wherein each component corresponds to a CCM with respect to a particular field, and wherein a CCM is a measure of creative output of said creator with respect to that particular field.

10. The system according to claim 8, wherein said viewer analytics engine is configured to generate said AV by assembling a plurality of affinity metrics (AMs) as vector components, wherein each component corresponds to an AM with respect to a particular field, and wherein an AM is a measure of said viewer's affinity toward that particular field.

11. The system according to claim 8, wherein said score is generated by forming a vector dot product of said CCV and said AV.

12. The system according to claim 8, wherein said creator/viewer analytics engine is configured to provide said creator recommendation to said viewer if said score exceeds a predetermined value.

13. The system according to claim 8, wherein said CCV is determined based upon at least one of a number of projects created by said creator, a number of views of projects of said creator, a number of appreciations of projects of said creator, and a number of exposures of projects of said creator.

14. The system according to claim 8, wherein said AV is determined based upon at least one of a number of views of projects performed by said viewer, a number of appreciations of projects, and a number of exposures of projects.

15. A computer program product including one or more non-transitory machine readable mediums encoded with instructions that when executed by one or more processors cause a process to be carried out for providing recommendations of creators to viewers in the context of a creative platform for publishing and viewing creative works, said process comprising:
receiving creator interaction data and generating a creative capital vector (“CCV”) based on said creator interaction data;
receiving viewer interaction data and generating an affinity vector (“AV”) based on said viewer interaction data;
generating a score for a creator with respect to a creator based upon said CCV and said AV; and
providing a creator recommendation to a viewer based upon said score.

16. The computer program product according to claim 15, wherein said CCV is generated by assembling a plurality of creative capital metrics (CCMs) as vector components, wherein each component corresponds to a CCM with respect to a particular field, and wherein a CCM is a measure of creative output of said creator with respect to that particular field.

17. The computer program product according to claim 15, wherein said AV is generated by assembling a plurality of affinity metrics (AMs) as vector components, wherein each component corresponds to an AM with respect to a particular field, and wherein an AM is a measure of said viewer's affinity toward that particular field.

18. The computer program product according to claim 15, wherein said score is generated by forming a vector dot product of said CCV and said AV.

19. The computer program product according to claim 15, wherein said creator recommendation is provided to said viewer if said score exceeds a predetermined value.

20. The computer program product according to claim 15, wherein said CCV is determined based upon at least one of a number of projects created by said creator, a number of views of projects of said creator, a number of appreciations of projects of said creator, and a number of exposures of projects of said creator, and wherein said AV is determined based upon at least one of a number of views of projects performed by said viewer, a number of appreciations of projects, and a number of exposures of projects.
